(19) United States
(12) Patent Application Publication
(10) Pub. No.: US 2025/0353207 A1
(43) Pub. Date: Nov. 20, 2025

(54) Method for machining conical wooden workpieces, device for carrying out such a method and planing machine with such a device

(71) Applicant: Michael Weinig AG, Tauberbischofsheim (DE)

(72) Inventors: Benjamin Frank, Boxberg (DE); Andreas Kuhn, Kitzingen (DE); Ralf Wagner, Hardheim (DE); Klaus Weisenseel, Ahorn-Berolzheim (DE); Josef Prenninger, St.Georgen bei Obernberg (AT)

(73) Assignee: Michael Weinig AG, Tauberbischofsheim (DE)

(21) Appl. No.: 19/208,751

(22) Filed: May 15, 2025

(30) Foreign Application Priority Data
May 17, 2024 (DE) 10 2024 001 646.5

(51) Int. Cl. B27C 5/02

(52) U.S. Cl. CPC B27C 5/02

(57) ABSTRACT

A method and device for machining conical wooden workpieces are disclosed. The workpiece has two long sides that are curved and lie at an angle to one another. A first planing tool planes one long side along its curvature, while a second planing tool planes the opposite long side along the same curvature, superimposed with a desired conicity. The second planing tool is adjusted transversely to the transport direction during planing. The device comprises two planing tools mounted on sliders, which are coupled and adjustable by a drive unit. A pressing unit and a scanning shoe enable precise guidance of the workpiece during machining, minimizing wood waste and maximizing yield.

### CROSS-REFERENCE TO RELATED APPLICATION

This application claims the benefit of German Patent Application No. DE 10 2024 001 646.5.3, filed 17 May 2024, the content of which is incorporated in its entirety.

### TECHNICAL FIELD

The disclosure relates to a method for machining conical wooden workpieces, a device for carrying out such a method, and a planer.

### BACKGROUND

It is known to separate logs into individual, plank-shaped wooden workpieces. These wooden workpieces usually have a conical shape. Since the long sides of such wooden workpieces are unclean and sometimes also contain wanes, the long sides are planed so that the wooden workpieces can be further machined, for example to produce carpets of boards. Here, two conical wooden workpieces that are twisted 180° against each other are placed with their long sides against each other. The pairs of boards formed in this way have a roughly rectangular outline. These pairs of boards are joined together with their long sides lying against each other to form wooden carpet, wherein the workpieces are glued together on their long sides. Panels, lamellas and the like, for example, are then separated from the carpet of boards.

The unmachined wooden workpieces coming from the sawmill often have a conical shape and the long sides are curved. The curved long sides are planed in such a way that it results in straight long sides angled in relation to each other, such that two wooden workpieces can then form a pair of boards in the manner described. Eliminating the curvature of the long sides leads to considerable wood waste and thus to a reduced wood yield.

### SUMMARY

An object of the disclosure is to design the generic method, the generic device and the planer in such a way that the conical wooden workpieces can be machined in such a way that there is only a small amount of wood waste and a high wood yield is achieved.

This object is solved with the method, the device, and the planer as disclosed and claimed.

The method for machining conical wooden workpieces is characterised in that the curvature of the wooden workpieces is followed during machining. The long sides of the wooden workpiece are planed in such a way that these long sides continue to be curved after the planing process. Since the curvature of the wooden workpieces is followed during machining, the wood waste due to machining is low, such that an optimal wood yield is achieved.

A first planing tool is used to plane one long side along the curvature of this long side and a second planing tool is used to plane the opposite long side of the wooden workpiece along the curvature of the one long side and overlaid with a desired conicity, in that the second planing tool is adjusted transversely to the transport direction relative to the first planing tool during the passage of the wooden workpiece.

If a scanning shoe is pressed against one long side of the wooden workpiece during machining, in conjunction with the joint adjustment of the two planing tools, it can be achieved that the curvature of the wooden workpiece can be reliably followed during workpiece machining.

To ensure precise and flawless machining, the curvature and conicity of the long sides of the wooden workpiece are advantageously recorded before machining.

The data characterising the conicity of the wooden workpiece is advantageously used to control the planing tools.

In the device for machining conical wooden workpieces, the planing tools are each mounted on a slider. Both sliders are coupled by at least one drive unit and can be adjusted relative to each other in a controlled manner by means of the drive unit. This allows the respective planing tool to be brought precisely into the correct position relative to the wooden workpiece passing through the device.

A structurally simple design results when the two sliders are displaceable on a common guide.

Advantageously, at least one pressing unit is arranged on the one slider, which abuts, under force, one long side of the wooden workpiece and presses or pulls a scanning shoe against the other long side of the wooden workpiece during machining. The pressing unit ensures that the scanning shoe is always pressed or pulled against the wooden workpiece during the passage of the wooden workpiece through the device and is thus perfectly guided.

The scanning shoe is advantageously arranged in front of the first planing tool in the direction of transport of the wooden workpiece. The scanning shoe can be used to adjust the degree of chip removal on one long side of the wooden workpiece.

An advantageous, cost-effective design emerges if the drive unit is connected to a control unit that receives data on the inlet-side width, the conicity and the chip removal on one long side of the workpiece to be machined. Based on this data, the control unit controls the drive unit in such a way that the corresponding planing tool can perform the required adjustment movements relative to the wooden workpiece. The invention is explained in more detail using exemplary embodiments.

### BRIEF DESCRIPTION OF THE DRAWINGS

FIG. 1 is a plan view of a curved workpiece, as it is delivered from a sawmill as a starting material.

FIG. 1a shows an example of a workpiece, as it is sawn out from a tree trunk.

FIG. 2 shows the workpiece according to FIG. 1 after a planing process according to prior art.

FIG. 3 shows the workpiece according to FIG. 1 after planing according to the design in accordance with the invention.

FIG. 4 is a schematic depiction of how a curved workpiece is straightened by a press.

FIG. 5 is a schematic depiction of the formation of a carpet of boards from workpieces abutting one another.

FIGS. 6 to 8 show the course of the procedure for machining curved workpieces according to the method in accordance with the invention and with a device in accordance with the invention.

FIG. 9 shows a second embodiment of a device according to the invention in a depiction corresponding to FIG. 6.

FIG. 10 shows, in a depiction corresponding to FIG. 9, a further embodiment of a device according to the invention.

FIG. 11 shows, in a depiction corresponding to FIG. 9, a further embodiment of a device according to the invention.

FIG. 12 is a schematic depiction of a planer having a device according to the invention.

### DETAILED DESCRIPTION

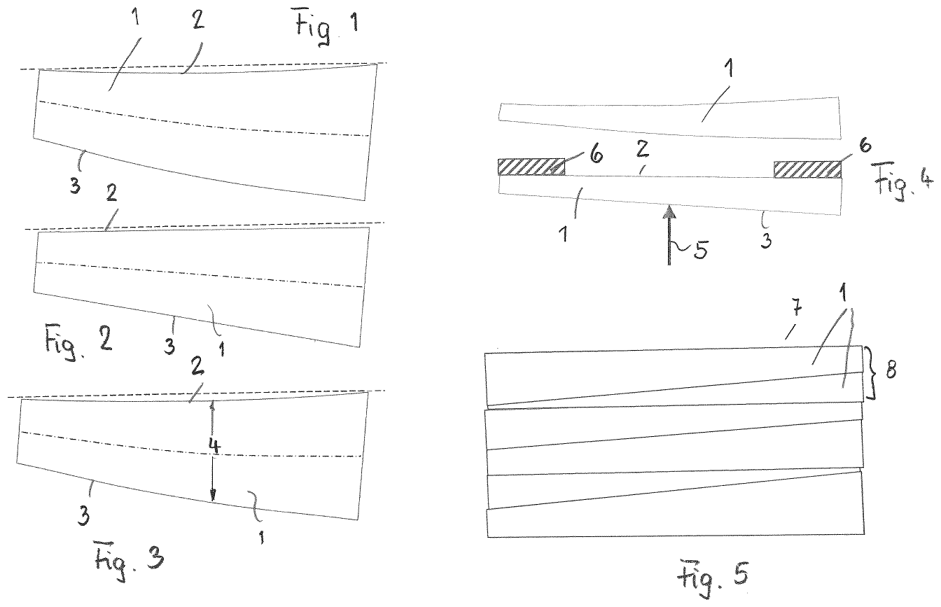

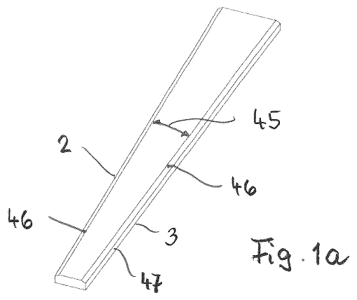

FIG. 1 shows a plan view of a conical workpiece 1 made of wood, as it is supplied by a sawmill after a tree trunk has been sawn open and a drying process has taken place. The workpiece 1 has conical long sides 2, 3 along its length due to the natural growth of the tree and curved due to residual stresses after sawing and the drying process. It is known to plane such a workpiece such that the long sides 2, 3 run linearly and conically to each other (FIG. 2).

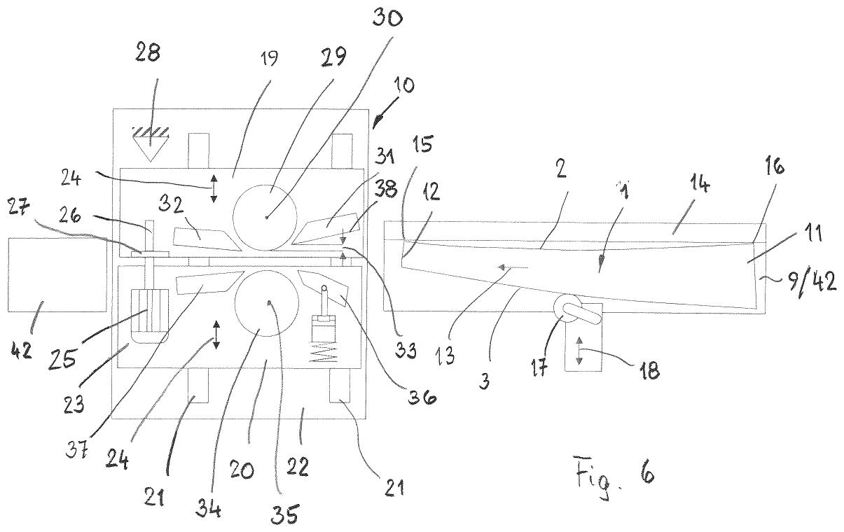

FIG. 3 shows the workpiece 1 after the method according to the invention has been carried out. The long sides 2, 3 are also curved along their length and run towards each other in such a way that the width 4 of the workpiece 1 decreases from one end to the other.

In contrast to the usual method, the curvature of the long sides 2, 3 of the workpiece 1 is followed when machining the workpieces.

FIG. 1a shows a workpiece as it has been sawn from a tree trunk. The workpiece is conical, as indicated by the conicity angle 45. The two long sides 2, 3 each have a wane 46 and a guide surface 47, which is generally rough sawn. In FIG. 1a, the wanes 46 are at the top and the guide surfaces 47 at the bottom.

During the planing process, the rough-sawn guide surfaces 47 are planed cleanly and the wanes 46 on the long sides 2, 3 are removed to such an extent that a surface suitable for gluing is generated. The workpiece 1 has a constant height or thickness over its length.

FIG. 4 shows schematically how the curved workpiece 1 according to FIG. 3 is straightened by a press.

FIG. 4 shows, in the upper image, the curved and planed workpiece 1 corresponding to FIG. 3. The press generates a compressive force 5, which is applied to the long side 3 transversely to the longitudinal direction of the workpiece 1. The workpiece 1 is supported on the opposite long side 2 by a support 6. The pressing process presses out the curvature of the workpiece 1.

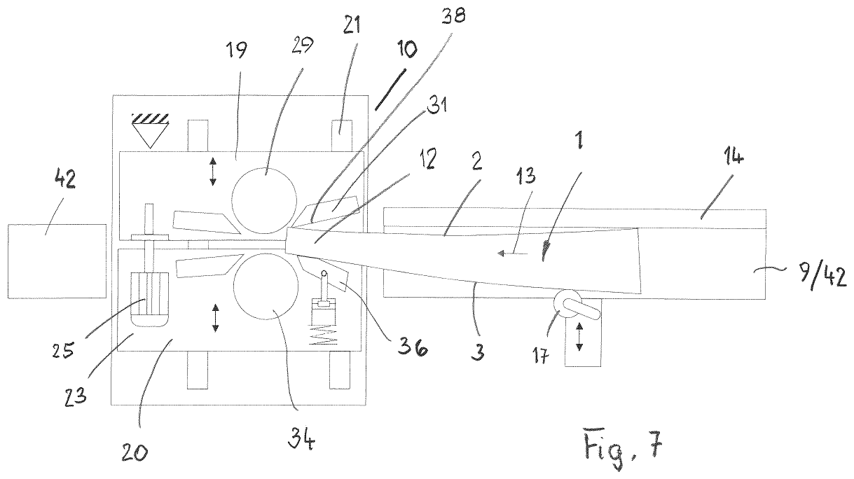

A carpet of boards 7 is formed with the planed and straightened workpieces 1 (FIG. 5). Every second workpiece 1 is rotated by 180°. Two workpieces 1 lying with their long sides against each other form a quasi-rectangular part 8, i.e. a pair of boards with an approximately rectangular outline. Several workpieces 1 arranged in this way form the carpet of boards 7 with their long sides lying against each other.

To form the parts 8, conical workpieces 1 that have the same or at least approximately the same conicity angle are placed against each other. This conicity of the workpieces 1 is defined by so-called conicity classes, into which the workpieces 1 are categorised depending on their conicity.

The workpieces 1 are firmly joined together in a known manner with their long sides lying against each other by means of an adhesive joint. This formation of carpets of boards is generally known and is therefore not explained in more detail.

The carpets of boards are formed in a known manner in presses by generating a compressive force transverse to the longitudinal direction of the workpieces 1 in the plane of the carpet of boards from one long side.

The resulting carpets of boards 7 are then sawn into parallel lamellas or board panels, which can then be used to produce centre layers or top layers of multi-layer boards, for example.

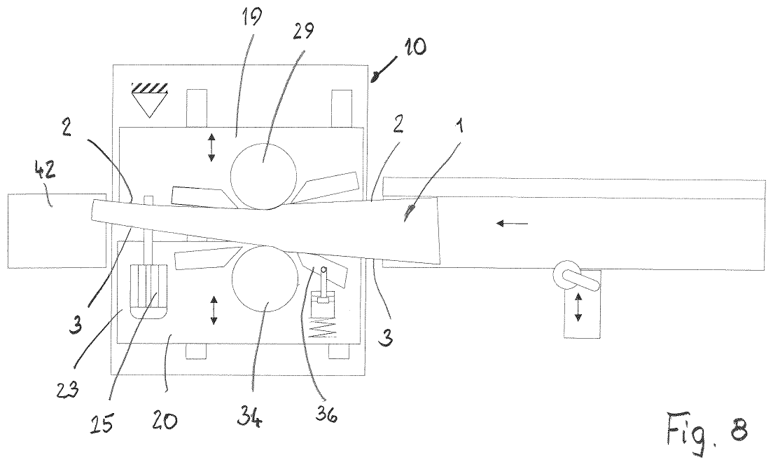

The workpiece 1 to be machined is fed on a feed table 9 (FIG. 6) to a device 10 forming part of a planer 48, in which the workpiece 1 is machined.

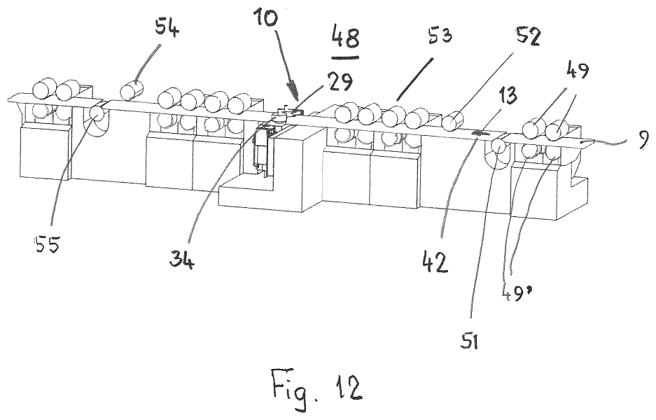

The planer 48 has the feed table 9 (FIG. 12). A machine table 42 is connected downstream of the feed table 9.

With a feed system 53, which is formed for example by feed rollers 49, table rollers 49′ and the like, the workpieces 1 are transported through the planer in the transport direction 13 and machined as they pass through. Such a feed system 53 is designed in a known manner such that it conveys the workpieces 1 through the planer 48 on a straight path and at a constant, adjustable feed speed.

In the area between the feed table 9 and the machine table 42 there is a lower, horizontal planing tool 51, with which the underside of the workpiece 1 is planed smooth as it passes through the planer 48. The workpiece 1 is then fed to a subsequent upper, horizontal planing tool 52 in order to machine the upper side of the workpiece 1. Machining with the planing tools 51, 52 ensures that the underside, which rests on the feed table 9 and machine table 42, and the opposite upper side of the workpiece 1 are planed perfectly smooth.

The workpieces 1 then reach the device 10 and are machined on the long sides 2, 3.

After passing through the device 10, the workpieces 1 can be machined again with an upper horizontal and then with a lower horizontal planing tool 54, 55.

In the following FIGS. 6 to 11, the feed table 9 and the machine table 42 in the area in front of the device 10 are schematically depicted as one unit and labelled 9/42. The tools 51, 52, 54, 55 and the feed system 53 are also not depicted for the sake of clarity.

The workpiece 1 has the two curved long sides 2, 3 which converge from the wider end 11 of the workpiece 1 in the direction of its narrow end 12. During its transport on the feed table 9/42 in the direction of the device 10, the long side 2 of the workpiece 1 abuts a stop 14 extending in the transport direction 13. As a result of its curved design, the long side 2 abuts the stop 14 at two areas 15, 16 that are spaced apart from each other.

The workpiece 1 is arranged on the feed table 9/42 in such a way that the hollow side 2 faces the stop 14 and, in the exemplary embodiment, the narrower end 12 of the workpiece 1 is at the front in the transport direction 13.

The workpieces 1 are fed in such a way that the wanes 46 are at the bottom. The position of the hollow long side 2 at the stop 14 and the wanes 46 at the bottom determines whether the narrow or wide end is at the front in the transport direction.

A pressure roller 17 abuts the curved long side 3 of the workpiece 1 and is pressed against the long side 3 with a force. The pressure roller 17 can, for example, be pressed against the long side 3 of the workpiece 1 in a spring-loaded or pneumatic manner.

The pressure roller 17 is known per se and is therefore not explained in more detail.

The pressure roller 17 is positioned in the direction of the arrow 18 according to the width of the workpiece 1 and its conicity, such that it is ensured that the workpiece 1 is reliably pressed against the stop 14 by the pressure roller 17.

The device 10 has a slider 19 on the right in the transport direction 13 and a slider 20 on the left. Both sliders 19, 20 can be adjusted on a guide 21 transversely, preferably perpendicular to the transport direction 13, which is illustrated by the arrows 24. In the exemplary embodiment, the guide 21 is formed by two guide rails lying parallel to one another, which are arranged on a machine stand 22.

An adjustment unit 23 can be used to move the left-hand slider 20 along the guide 21 relative to the right-hand slider 19. The adjustment unit 23 has a drive motor 25, which is arranged on the left-hand slider 20. The drive motor 25 has a drive spindle 26, which extends over the right-hand slider 19. A nut 27 sits on the drive spindle 26 and is firmly attached to the right-hand slider 19. Depending on the direction of rotation of the drive spindle 26, the slider 20 is adjusted outwards or inwards transversely to the transport direction 13.

There is a stop 28 in the adjustment path of the right-hand slider 19, which determines the maximum adjustment path of the slider 19.

There is a right-hand tool 29 on the right-hand slider 19, which is driven to rotate about a vertical axis 30. The axis of rotation 30 is perpendicular to the transport direction 13.

A scanning shoe 31 is located on the slider 19 in front of the tool 29 in the transport direction 13. This is used to set the extent 33 of the chip removal on the curved long side 2 of the workpiece 1.

A guide shoe 32 located behind the tool 29 in the transport direction 13 is set such that it rests against the machined long side 2 of the workpiece 1.

A tool 34, which can be driven to rotate about a vertical axis 35, is also located on the left-hand slider 20. The axis of rotation 35 is also perpendicular to the transport direction 13. The tool 34 is used to machine the left-hand long side 3 of the workpiece in the transport direction.

The two tools 29, 34 are advantageously located next to each other at the same height in the transport direction 13, such that the machining forces act on the workpiece 1 on both long sides 2, 3 at approximately the same height and the geometric, dimensional accuracy is guaranteed in the method according to the invention.

In the transport direction 13 in front of the tool 34, a pressing shoe 36 is located on the slider 20, which is loaded in the direction of the workpiece 1 and can be moved transversely to the transport direction 13 such that it can compensate for differences in raw wood. The pressing shoe 36 can, for example, be pressed against the long side 3 of the workpiece 1 in a spring-loaded or pneumatic manner.

In the transport direction 13 behind the tool 34, a guide shoe 37 sits on the slider 20, which can abut the left long side 3 of the workpiece 1.

The two sliders 19, 20 are coupled to each other via the adjustment unit 23. As a result, the two sliders 19, 20 can be moved freely together on the guide 21 when the workpiece 1 is machined on its curved long sides 2, 3. In other words, they can jointly follow the curvature of the workpiece 1 passing through.

FIG. 6 shows the workpiece 1 before it enters the device 10. The workpiece 1 is fed to the device 10 on the feed table 9 or machine table 42, wherein it is guided over the contact areas 15, 16 on the longitudinal stop 14.

FIG. 7 shows the situation when the workpiece 1 enters the device 10. The workpiece 1 runs with its narrower end 12 onto the scanning shoe 31 and the pressing shoe 36. Since the scanning shoe 31 is fixed in its respective set position relative to the neighbouring tool 29, the two slides 19, 20 are displaced as a unit along the guide 21 during machining, corresponding to the curvature of the long sides 2, 3 of the workpiece 1 to be machined.

As the workpiece 1 enters the device 10, the workpiece is always pressed against the longitudinal stop 14 by the pressure roller 17, such that the workpiece can be fed into the device 10 without any problems. It is taken over by the feed system 53 and transported in a straight line through the device 10 as described.

The scanning shoe 31 is provided and the longitudinal stop 14 arranged in such a way that the end 12 of the workpiece 1 meets the scanning shoe 31 shortly after leaving the longitudinal stop 14.

The scanning shoe 31 has a side surface 38 facing the workpiece 1 and lying at an angle to the transport direction 13, which abuts the right long side 2 of the workpiece 1 after it has entered the device 10, such that the long side 2 can be machined by the tool 29 to the required extent and with the set chip removal.

Since the pressing shoe 36 bears against the workpiece 1 under force, it ensures that the two sliders 19, 20 are adjusted transversely to the transport direction 13 in such a way that the scanning shoe 31 is always pressed against the long side 2 of the workpiece 1 during the planing process and bears against it. In this way, the tools 29, 34 of the two sliders 19, 20 follow the curvature of the long side 2.

As can be seen in FIG. 7, the pressing shoe 36 is opposite the scanning shoe 31.

The curved long side 2 of the workpiece 1 is machined (planed) with the tool 29 and the curved long side 3 with the opposite tool 34.

So that the curved long sides 2 and 3 of the workpiece 1 are machined simultaneously with the two tools 29, 34 and that the curvature of the long sides 2, 3 is not eliminated by the machining process, the two sliders 19, 20 are moved during transport through the device 10 as described such that the tools 29, 34 follow the curvature of the long side 2 of the workpiece 1. The left-hand slider 20 with the tool 34 is also continuously adjusted relative to the tool 29 during the passage of the workpiece 1 in order to obtain the required conicity of the workpiece 1. The workpieces are fed to the feed table 9, 42 in the correct position, with the hollow side facing the stop 14 and the wanes 46 facing downwards. As the input variables for the control of the planer 48 with the device 10, the width on the infeed side, the conicity/conicity class, the progression of the conicity from wide to narrow or from narrow to wide and the desired chip removal on the right long side 2 must be transferred for each workpiece 1 fed in. These values are known before they are fed onto the feed table 9 of the planer 48, for example by scanning the workpieces 1 or recording them using sensors, cameras and the like. The conicity class is already known from the sawing process. Before the individual workpiece 1 is fed to the device 10, this data is used to bring the two tools 29, 34 of the device 10 into a basic position and to control the position of the left-hand tool 34 during the workpiece passage by means of the adjustment unit 23.

For the process sequence, it is necessary to recognise the start and end of the wood as seen in the transport direction 13. For this purpose, known sensors, not depicted, are provided within the moulding machine. The detection of the start of the wood, in conjunction with the transport speed, determines the position of the workpiece 1 within the device 10. This controls the start of the relative adjustment (width adjustment) of the left-hand tool 34 to produce the desired conicity. The detection of the end of the wood is used to recognise when the workpiece 1 has left the device 10 in order to be able to start the positioning of the sliders 19, 20 in the basic position for the subsequent workpiece 1. FIG. 8 shows the workpiece 1 that has been partially moved between the two tools 29, 34. It can be seen that both tools 29, 34 remove material from the curved long sides 2, 3 of the workpiece 1. It can also be seen that the curvature of these long sides 2, 3 is maintained by machining the workpiece 1. After passing through the device 10, the workpiece 1 is given a conical shape, wherein the long sides 2, 3 are not straight but curved.

During the passage of the workpiece 1 through the device 10, the left-hand tool 34 is continuously adjusted towards the right-hand tool 29 in the manner described in accordance with the desired conicity of the workpiece. The distance between the two tools 29 and 34, starting from the beginning of machining (FIG. 7), becomes increasingly wider according to the conicity of the workpiece 1. It can also be seen that the right-hand slider 19 has moved away from the stop 28 following the curvature of the wood compared to the position according to FIG. 6.

In the exemplary embodiment, the left-hand tool 34 is adjusted by one centimetre for every metre of length of the workpiece 1, for example, such that the width of the workpiece 1 increases from the narrow end 12 by 1 cm for every Im of length. This achieves an optimum wood yield if the starting board had a corresponding conicity.

These dimensions are not to be understood as limiting. The widening of the workpiece 1 can also have other values.

During the passage of the workpiece 1, the entire unit, consisting of the two sliders 19, 20, is adjusted together in order to be able to forcibly follow the curvature of the workpiece 1. The spring-loaded pressing shoe 36 always presses the scanning shoe 31 against the workpiece 1. In this way, the wood yield is optimised, i.e. the waste of workpiece material is minimal. The pressing shoe 36 always pulls the slider unit 19, 20 in the direction of the workpiece 1.

The floating adjustment of the two sliders 19, 20 follows the curvature of the long sides 2, 3 of the workpiece 1. The degree of conicity of the workpiece 1 is determined by the continuous relative adjustment of the tool 34.

As explained with reference to FIG. 4, the curvature of the workpiece 1 is pressed out in the gluing press in a subsequent process, such that the carpet of boards 7 can be produced with the correspondingly shaped workpieces 1. The machined workpiece 1 is guided on the machine table 42 from the planer 48 with the device 10.

The drive motor 25 of the adjustment unit 23 is advantageously a servomotor, with which it is possible to precisely adjust the left slider 20 with the tool 34.

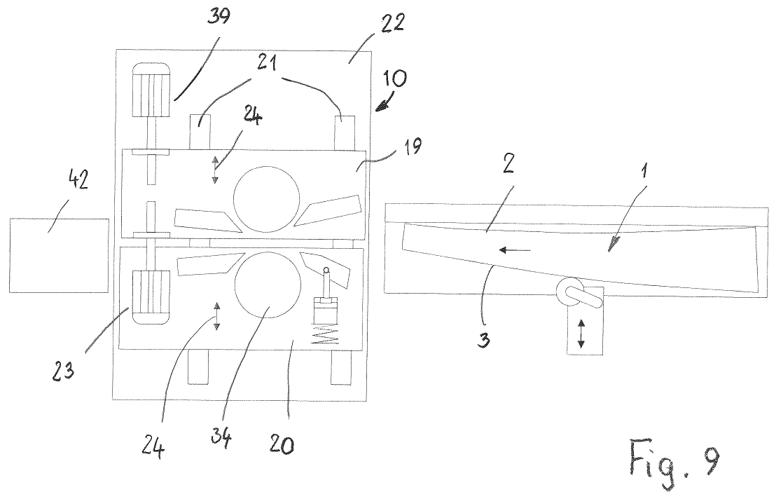

FIG. 9 shows an embodiment of a device 10 in which the slider 19 can be adjusted together with the slider 20 in the adjustment direction 24 by means of an adjustment unit 39. By way of example, the drive unit 39 has the same design as the drive unit 23, with which the slider 20 can be adjusted relative to the slider 19 in the adjustment direction 24.

The drive unit 39 is arranged on the machine stand 22 and is used to move the two sliders 19, 20 on the guide 21 to a basic position. It depends on how the workpiece 1 is moved into the device 10 and is depicted as an example in FIG. 6. The two sliders 19, 20 are coupled to each other via the drive unit 23 in the manner described above by means of the drive unit 23. The drive unit 39 replaces the stop 28 of the previous embodiment.

The unit consisting of the two sliders 19, 20 is held in the basic position until the tool 34 is moved to a basic position by moving the slider 20 in the adjustment direction 24 relative to the slider 19 by means of the drive unit 23. This basic position is determined by the width of the workpiece 1 to be fed on the infeed side. Depending on the ratio of the outfeed-side width of the previously machined workpiece 1 and the infeed-side width of the workpiece 1 to be subsequently fed, the left-hand tool 34 must cover a large adjustment path within a short time. This short time minimises the gap between successive workpieces 1 and thus achieves high productivity. The desired rapid adjustment of the left-hand slider 20 results in large inertia forces, the reaction forces of which must be absorbed by holding the slider unit.

To enable to the unit consisting of the two sliders 19, 20 to follow the curvature of the long sides 2, 3 of the workpiece 1 during machining in the manner described, this unit is decoupled from the drive unit 39 such that it can move in a free-floating manner on the machine stand 22 along the guide 21. This release can be achieved, for example, by decoupling the slider 19 from the drive unit 39.

Instead of the drive unit 39, the slider 19 can also be adjusted and held in place relative to the machine stand 22 by a pneumatic or hydraulic cylinder, for example. It is also possible to simply clamp the slider 19 and thus the slider unit 19, 20.

Advantageously, a linear motor can be used to adjust the slider unit 19, 20, with which the unit can be precisely positioned and which also enables decoupling such that the slider unit 19, 20 can move freely (floating) during machining of the workpiece 1.

In all other respects, the device 10 has the same design as the previous exemplary embodiment. The workpiece 1 is also machined in the same way as in the previous exemplary embodiment.

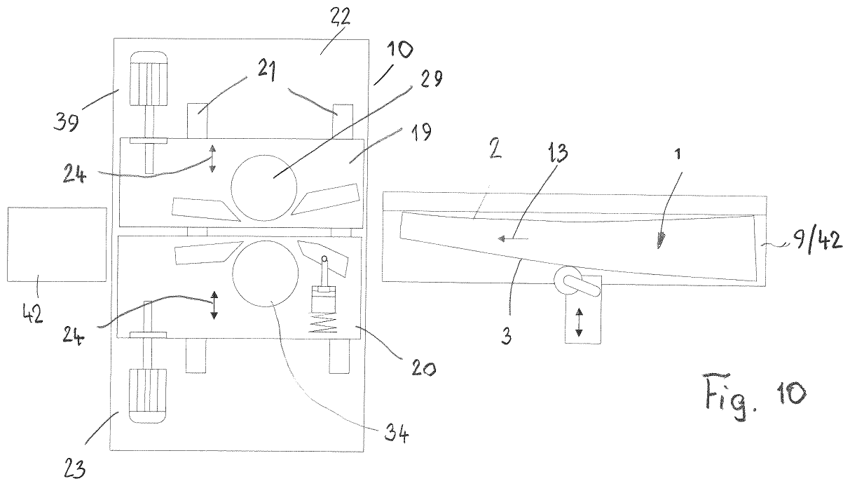

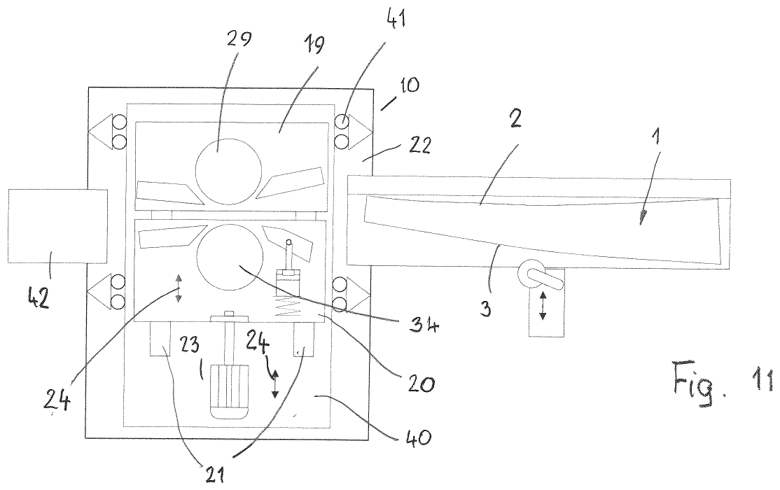

FIG. 10 shows a further embodiment of the device 10, with which the workpieces 1 can be machined in the manner described. Both sliders 19, 20 can be adjusted independently of one another by their own drive unit 23, 39. Both drive units 23, 39 are arranged on the machine stand 22.

The drive unit 23 is independent of the drive unit 39.

The position of the right-hand slider 19 is detected by a measuring system and transmitted to the control system virtually simultaneously as the basic value for adjusting the left-hand slider 20 and thus the left-hand tool 34. The conicity of the workpiece 1 is added to the base value, i.e. superimposed on the curvature as in the previous exemplary embodiments, for the adjustment of the left-hand slider 20 or the left-hand tool 34.

The left drive unit 23 is independent of the right drive unit 39 and is formed by a CNC drive, for example a servo or linear motor.

Otherwise, the device 10 is designed in the same way as the exemplary embodiment shown in FIGS. 6 to 8. The machining of the curved long sides 2, 3 of the workpiece 1 occurs in the method described for this embodiment.

A further development of the device 10 according to FIG. 10 is to design both drive units 23, 39 as independent CNC drives and to connect them to a control system with which the drive units 23, 39 are adjusted independently of each other. The curved shape of the long sides 2, 3 and the conicity of the workpiece 1 can be determined by a scanner or a camera. Based on this, the control system can determine the adjustment of the two sliders 19, 20 depending on the transport path of the workpiece 1 or the workpiece position in order to achieve the desired machining. A prerequisite for maintaining the predetermined workpiece position is that the workpiece 1 is guided precisely. This can be achieved, for example, by guiding the workpiece 1 through the device 10 by means of a groove-web guide, which is not described in detail. In this case, the machine table 42 is provided with at least one projecting web extending in the transport direction 13, which engages in a corresponding groove on the underside of the workpiece 1, also extending in the transport direction 13.

The drive units 23, 39 can be used to adjust the tools 29, 34 precisely such that the workpiece 1 has the desired curvature of the long sides 2, 3 and the desired conicity after passing through the device 10.

In the embodiment according to FIG. 11, the sliders 19, 20 with the tools 29, 34 are arranged on a base slider 40, on which the guide 21 for the slider 20 is located. The base slider 40 is guided on the machine stand 22 in the direction of adjustment 24 by at least one guide 41.

The drive unit 23 is arranged on the base slider 40, with which the left-hand slider 20 can be adjusted relative to the right-hand slider 19 on the base slider 40 in the direction of adjustment 24.

The two sliders 19, 20 with their tools 29, 34 are mounted on the base slider 40 in a free-floating manner in the direction of adjustment 24, such that the tools 29, 34 can follow the curvature of the long sides 2, 3 of the workpiece 1 during machining in the manner described. The drive unit 23 can be used to adjust the tool 34 according to the desired conicity of the workpiece 1 during machining, as explained with reference to FIGS. 7 and 8.

The process sequence for machining the workpiece 1 is carried out as described. The two sliders 19, 20 are also designed in accordance with the previous embodiments.

The unmachined workpieces 1 are advantageously sorted into conicity classes, which are determined, for example, by the cone angle that the long sides 2, 3 of the workpiece 1 enclose with each other, or by a fixed increase or decrease in width per running metre of the workpiece 1. In the production of the carpet of boards 7 (FIG. 5), two machined workpieces of the respective conicity class are always placed against each other rotated by 180°, forming the part 8. On the gluing press, the machined lamellar workpieces 1 abutting each other and forming the carpet of boards 7 are then pressed in such a way that the curvature of the long sides 2, 3 is pressed out.

In the exemplary embodiments depicted, the workpiece 1 is fed to the device 10 in such a way that the narrow end 12 of the workpiece 1 enters the device 10 first. However, the workpiece can also be arranged such that its wide end 11 is the first to enter the device 10. The left-hand tool 34 is adjusted accordingly as the workpiece 1 passes through.

The illustrated exemplary embodiments show a planer in which the workpieces are transported from right to left. Alternatively, the planer can also be designed such that the transport takes place from left to right. In such an embodiment, the designations ‘left’ and ‘right’ are reversed compared to the embodiments described.

Some advantageous dimensions are specified below, but these are not to be understood as a restriction:
Feed speed: 120 m/min
Workpiece width: 80-300 mm
Workpiece thickness: 20-50 mm
Workpiece length: 2-5 m
Conicity classes: 0-20 mm/meter
Wood curvature: 0-2 mm/meter.

1.-10. (canceled)

11. A method for machining a conical wooden workpiece (1), the conical wooden workpiece (1) having long sides (2, 3) lying at an angle to one another and running curved over their length, the method comprising:
planing a first long side (2) of the long sides (2,3) with a first planing tool (29) along a first curvature of the first long side (2); and
planing an opposite second long side (3) of the long sides (2,3) with a second planing tool (34) along the first curvature of the first long side (2) superimposed with a desired conicity; and
adjusting the second planing tool (34) relative to the first planing tool (29) transversely to a transport direction (13) of the conical wooden workpiece (1) during planing.

12. The method according to claim 11, further comprising:
pressing a scanning shoe (31) against the first long side (2) of the conical wooden workpiece (1) during planing.

13. The method according to claim 11, further comprising:
detecting the first curvature of the first long side (2), a second curvature of the second long side (3), and a conicity of the conical wooden workpiece (1) before planing.

14. The method according to claim 13, further comprising:
using data characterizing the conicity for controlling the first planing tool (29) and the second planing tool (34).

15. A device, comprising:
two planing tools (29, 34) for machining long sides (2, 3) of a wooden workpiece (1),
wherein each of the two planing tools (29, 34) sits on a slider (19, 20), and both sliders (19, 20) can be adjusted transversely to a transport direction (13) of the wooden workpiece (1),
wherein the sliders (19, 20) are coupled by a drive unit (23) and can be displaced relative to each other in a controlled manner by the drive unit (23), and
wherein the device is configured to perform the following steps:
planing a first long side (2) of the long sides (2,3) with a first planing tool (29) of the two planing tools (29, 34) along a first curvature of the first long side (2); and
planing an opposite second long side (3) of the long sides (2,3) with a second planing tool (34) of the two planing tools (29, 34) along the first curvature of the first long side (2) superimposed with a desired conicity; and
adjusting the second planing tool (34) relative to the first planing tool (29) transversely to the transport direction (13) of the wooden workpiece (1) during planing.

16. The device according to claim 15,
wherein both sliders (19, 20) are displaceable on a common guide (21).

17. The device according to claim 15,
wherein a pressing unit (36) is arranged on one of the sliders (20),
wherein the pressing unit (36) presses under force against the second long side (3) of the wooden workpiece (1) and presses a scanning shoe (31) against the first long side (2) of the wooden workpiece (1) during planing.

18. The device according to claim 17,
wherein the scanning shoe (31) is arranged in front of the first planing tool (29) in the transport direction (13) of the wooden workpiece (1), and
wherein an extent (33) of chip removal on the first long side (2) of the wooden workpiece (1) can be adjusted.

19. The device according to claim 15,
wherein the drive unit (23, 39) is connected to a control system, and
wherein data on an infeed-side width, conicity, and chip removal on the first long side (2) are transferred to the control system.

20. A planer, comprising the device according to claim 15.
